(19) United States
(12) Patent Application Publication
(10) Pub. No.: US 2015/0098468 A1
(43) Pub. Date: Apr. 9, 2015

(54) METHOD OF CONTROLLING ROUTING OF IDENTIFIER/LOCATOR MAPPING SERVICE

(71) Applicant: ELECTRONICS AND TELECOMMUNICATIONS RESEARCH INSTITUTE, Daejeon (KR)

(72) Inventors: Jung-Im KIM, Daejeon (KR); Tae Ho LEE, Daejeon (KR); Tae Wan YOU, Daejeon (KR); Heeyoung JUNG, Daejeon (KR); Woojik CHUN, Seoul (KR)

(73) Assignee: ELECTRONICS AND TELECOMMUNICATIONS RESEARCH INSTITUTE, Daejeon (KR)

(21) Appl. No.: 14/272,711

(22) Filed: May 8, 2014

(30) Foreign Application Priority Data
Oct. 4, 2013 (KR) 10-2013-0118716

(51) Int. Cl. H04L 12/721; H04L 12/761

(52) U.S. Cl. CPC H04L 45/44; H04L 45/16
USPC 370/390

(57) ABSTRACT

A method of controlling routing of an identifier/locator mapping service that can secure security regarding location information without a scalability problem and that can support mobility is provided. By generating a domain group by forming a plurality of domains in a group, a scalability problem of an ID/LOC mapping table for ID of a flat structure can be solved. An identifier of a communication object existing at each domain is managed using a counting bloom filter, and thus a message overhead of a mapping service can be reduced. Further, by enabling ID/LOC mapping table information to remain within a domain, location information of a communication object can be protected.

### CROSS-REFERENCE TO RELATED APPLICATION

This application claims priority to and the benefit of Korean Patent Application No. 10-2013-0118716 filed in the Korean Intellectual Property Office on Oct. 4, 2013, the entire contents of which are incorporated herein by reference.

### BACKGROUND OF THE INVENTION

(a) Field of the Invention

The present invention relates to a method of controlling routing by separating a locator and an identifier.

(b) Description of the Related Art

In general, the Internet includes location and identifier information in an Internet protocol (IP), and routes a packet using the IP.

The Internet may be formed with an autonomous system (AS), and in this case, the AS is a network or a network group to be managed by a single management institution.

A border gateway protocol (BGP) is used for inter-domain routing of the AS. In this case, the BGP enables a packet to be routed between ASs by managing an IP prefix with a routing table. That is, the packet may start from one AS and arrive at a destination AS via another AS using a BGP.

However, in the Internet nowadays, because a size of a BGP routing table (IP prefix) very quickly increases, a path vector routing method of the BGP cannot operate. A problem of such Internet is referred to as a scalability problem. Further, the BGP consumes much time in changing an entire routing table that is spread all over the world to the same value. Such an Internet problem is referred to as a convergence time problem.

Maintaining network security indicates, when data is transferred, a case in which three elements of integrity in which data is not changed in an intermediate process, of provenance that determines that data was generated at a desired location of a receiver, and of relevance in which request data of a receiver is transferred are satisfied. Presently, in order to solve a network security problem, IP Security (IP Sec) is used in a network layer, but IP Sec is used only in a limited range.

Therefore, in the Internet, scalability, a convergence time, Internet security, and mobility support of a BGP table are a problem to urgently solve.

Scalability and a convergence time problem of a BGP table should be considered when designing an entire mapping table. Nowadays, in order to solve a problem such as a scalability problem, mobility, multihoming, and session management of a BGP table, research on an identifier/locator (ID/LOC) mapping method that are included in IP is being performed.

The locator/identifier mapping method is divided into a hierarchical structure and a flat structure based on a characteristic of identification (ID). One of a research field in which ID is a hierarchical structure is a locator/identifier separation protocol (LISP), and one of a research field which is a flat structure is MobilityFirst.

An ID/LOC mapping method that is suggested in an LISP includes LISP-alternative topology (LISP-ALT) and LISP-distributed hash tables (LISP-DHT), and an ID/LOC mapping method that is suggested in MobilityFirst includes a direct mapping (DMap) method.

When ID is a hierarchical structure, in order to solve a scalability problem, an ID/LOC mapping table may use a hierarchical structure.

Presently, the Internet routes a packet using an IP, but in a system in which ID and LOC are separated, mapping information (ID/LOG mapping information) about a location of a communication object corresponding to ID that is given to perform routing should be managed.

In order to quickly acquire information about ID and LOC, many researches consider a method of storing mapping information of ID and LOC at several locations and obtaining ID/LOC mapping information that is stored at a nearest location. In this method, when an LOC is changed, LOC information in distributed ID/LOC mapping information should be quickly updated.

In this case, as a node that stores the same ID/LOC mapping information increases, an update message increases, and thus a cost increases and a convergence time increases. Further, when many communication objects exist, upon describing an entire communication object in a mapping table, much search time may be consumed due to a large size of the mapping table. Further, to store ID/LOC mapping information at a node at which an ID/LOC inquiry message does not arrive may be an example of inefficiently operating a mapping table.

Therefore, a method of efficiently managing an ID/LOC mapping table by distributing and storing the mapping table according to a previously determined rule has appeared. The method includes a method of distributing a mapping table with a method that is related to a location of a communication object and a method of distributing a mapping table with a method regardless of a location of a communication object.

LISP-ALT separates ID and LOC with a backward compatibility method of a present Internet system, and distributes and stores an IP/LOC mapping table using an IP. In this case, an LISP-ALT method may hierarchically store a mapping table using a hierarchical structure of an IP. However, design requirements of future Internet researchers cannot be satisfied with only a hierarchical structure of an IP.

In MobilityFirst, a DMap method stores an ID/LOC mapping table, which is a flat structure, regardless of a location of a communication object. That is, by putting a public key of a node to a hash function, a front portion of an output value is analyzed as an IP prefix, and an ID/LOC mapping table of a corresponding IP prefix is stored. Thereafter, for fast search, by storing an output value that is obtained by inputting a public key of a communication object to several hash functions at several nodes, the ID/LOC mapping table may be acquired at an adjacent node. However, because MobilityFirst is performed on the assumption that an ID/LOC mapping table is stored at a server node of several ASs, when several ASs are operated with different policies, there is a drawback that the same ID/LOC mapping table cannot be overlappingly stored.

### SUMMARY OF THE INVENTION

The present invention has been made in an effort to provide a method of controlling routing of an identifier/locator mapping service having advantages of securing security regarding location information without a scalability problem, and supporting mobility.

An exemplary embodiment of the present invention provides a method of controlling routing in which a domain including a plurality of nodes that are operated with the same policy enters a first domain group including a plurality of domains that are different from the domain through a domain gateway of the domain. The method includes: receiving a plurality of beacons that are broadcasted from a plurality of domain groups; determining a policy of the plurality of domain groups by analyzing the plurality of beacons; transmitting a response message to the beacon to a first domain group that is selected according to the policy of the plurality of domain groups; receiving a grouping beacon from the first domain group; and transmitting, when the grouping beacon is received within a predetermined time, an ACK message to the first domain group.

Each beacon of the plurality of beacons may include an intrinsic number and pattern of a domain group that broadcasts the beacon.

The determining of a policy may include determining information about a policy in which the domain group is operated by analyzing the pattern.

The response message may include a domain identifier of the domain.

The grouping beacon may receive the response message from a domain group leader of the first domain group, transmit the response message after a predetermined time, and include the domain identifier and an intrinsic number of the first domain group.

The method may further include transmitting identifier table information including an identifier of a communication object that is connected to the plurality of nodes to the first domain group, after transmitting the ACK message.

The identifier of the domain may be managed with the identifier table information, and the identifier and a locator of the communication object may be mapped according to an identifier/locator mapping method of the domain.

The identifier may be recorded in the identifier table information with a counting bloom filter.

Another embodiment of the present invention provides a method of controlling routing in which a domain group including a plurality of domains updates identifier table information. The method includes: receiving, when a communication object enters an area of a first domain of the plurality of domains, first identifier table information of the first domain to which an identifier of the communication object is added from the first domain; updating second identifier table information of the domain group using the first identifier table information; and reporting, by the communication object, that the communication object is registered at the first domain to a domain group that is located before the communication object enters.

The plurality of domains may include a plurality of nodes that are operated with the same policy, and the communication object may be connected to at least one node of the plurality of nodes.

Yet another embodiment of the present invention provides a method of controlling routing in which a domain group including a plurality of domains searches for a destination. The method includes: receiving an inquiry message about identifier and locator information of the destination; determining identifier table information that the domain group has and searching for the identifier; and transferring, when the identifier exists in a first domain of a plurality of domains that are included in the domain group, the inquiry message to a domain gateway of the first domain.

The method may further include: searching for, when the identifier does not exist in identifier table information that the domain group has, the identifier table information that a domain group different from the domain group has; and transferring, when the identifier exists in a second domain of a plurality of domains that are included in the other domain group, the inquiry message to the other domain group.

The domain group may have entire identifier table information that a plurality of domains that are included in the domain group have.

The domain group may share the identifier table information that a domain group that is different from the domain group has.

The plurality of domains may include a plurality of nodes that are operated with the same policy, and a communication object may be connected to at least one node of the plurality of nodes.

In this way, according to the exemplary embodiment of the present invention, by generating a domain group by forming a plurality of domains in a group, a scalability problem of an ID/LOC mapping table for ID of a flat structure can be solved. In this case, an identifier of a communication object existing at each domain is managed using a counting bloom filter, and thus a message overhead of a mapping service can be reduced. Further, by enabling ID/LOC mapping table information to remain within a domain, location information of a communication object can be protected.

### BRIEF DESCRIPTION OF THE DRAWINGS

FIG. 1 is a diagram illustrating a domain network according to an exemplary embodiment of the present invention.

FIG. 2 is a flowchart illustrating a method of generating a domain group according to an exemplary embodiment of the present invention.

FIG. 3 is a flowchart illustrating a register procedure of a communication object according to an exemplary embodiment of the present invention.

FIG. 4 is a flowchart illustrating an ID/LOC mapping inquiry procedure according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation, and can be implemented by hardware components or software components and combinations thereof.

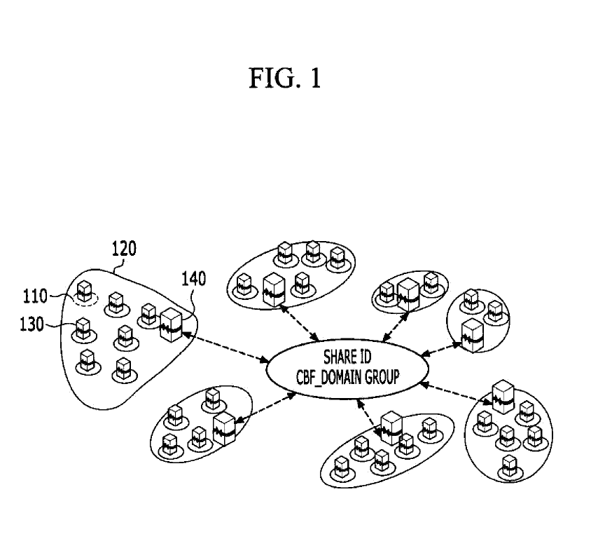

FIG. 1 is a diagram illustrating a domain network according to an exemplary embodiment of the present invention.

Referring to FIG. 1, a domain network according to an exemplary embodiment of the present invention includes a domain including a plurality of nodes that are operated with the same policy, and a domain group that is formed with a plurality of domains.

A node that may represent a domain among nodes that are included in each domain may be a domain gateway. Each domain may interface with another domain through a domain gateway. In this case, the domain gateway may store ID of a communication object (host, service, or contents) existing at a domain at an ID counting bloom filter Domain (ID CBF_Domain).

In this case, the CBF is an element of technology that overcomes a drawback of a bloom filter (BF). That is, a BF is a data structure that can be used when testing whether a specific element belongs to a set, and has a merit that it can efficiently and quickly search for a large amount of data, but has a drawback that addition of an element is available and deletion of an element is unavailable. However, because the CBF may know that a plurality of elements were recorded at which portion of a filter, the CBF may delete an element. According to an exemplary embodiment of the present invention, ID of a communication object existing at a network is stored as a CBF.

A node that may represent a domain group among nodes that are included in each domain group may be a domain group leader. A domain group leader may store ID of a communication object existing at a domain group at an ID counting bloom filter_domain group (ID CBF_Domain Group).

Further, in order to obtain information about a domain at which a communication object existing at a domain group is located, the domain group leader may manage an ID CBF_Domain of each domain.

Further, the domain group leader may share an ID CBF_Domain Group of each domain group. When the domain group leader receives an ID/LOC mapping inquiry message by interfacing between domain groups, the domain group leader searches for ID of a communication object in an ID CBF_Domain Group, and when a communication object exists at another domain group, the domain group leader transmits an ID/LOC response message to a leader of another domain group.

When generating a domain group by forming a plurality of domains in a group, as in the present invention, a scalability problem of an ID/LOC mapping table for ID of a flat structure can be solved. When searching for a domain group at which corresponding ID is located by searching for a CBF of each domain group, and when searching for a domain by searching for a CBF of a domain that is included in the domain group rather than a method of dividing a mapping table with the number of communication objects that are included in the domain and obtaining ID/LOC mapping information by searching for each domain, ID/LOC mapping information in which a corresponding domain supports may be searched for. Further, when several domain gateways transmit an ID/LOC mapping inquiry to only the domain group leader, the number of inquiry messages can be reduced, compared with when directly transmitting to another domain gateway.

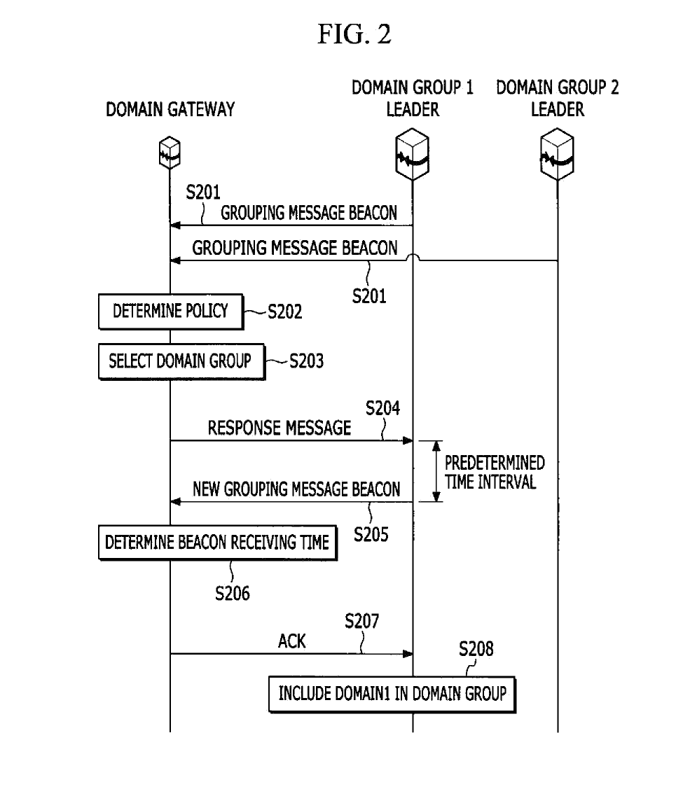

FIG. 2 is a flowchart illustrating a method of generating a domain group according to an exemplary embodiment of the present invention.

Referring to FIG. 2, a domain group leader first broadcasts a beacon that guides a group (S201). In this case, the beacon includes an intrinsic number of a domain group, and a pattern of the beacon includes information about a policy in which a corresponding domain group operates.

The domain gateway, having received a beacon that is broadcasted from the domain group leader, analyzes a pattern of the beacon and determines a policy of each domain group (S202). In an exemplary embodiment of the present invention, a domain gateway may represent a domain A.

Thereafter, the domain gateway selects a domain group through a determined policy (S203). For example, when a policy on a low cost is determined, a domain group of a domain provider that provides a low cost service may be selected, and when a policy on QoS is determined, a domain provider may select a domain group that guarantees quality. The domain gateway transmits a response message of the received beacon toward the selected domain group leader (S204).

In this case, the domain gateway may transmit a response message using an intrinsic number of a domain group that is included in the beacon, and the response message that the domain gateway transmits includes a domain identifier of a domain. In an exemplary embodiment of the present invention, the domain gateway transmits a response message to a leader of a domain group 1.

The leader of the domain group 1, having received a response message from the domain gateway, broadcasts a new grouping message beacon after a predetermined time from a time point when a response is received (S205). In this case, the new grouping message beacon includes an intrinsic number of a domain group and a domain identifier that is included in the response message. In an exemplary embodiment of the present invention, a leader of the domain group 1 may transmit a new grouping message beacon after a few seconds.

Thereafter, the domain gateway receives a new grouping message beacon and determines a receiving time (S206). For example, the domain gateway may determine a consumed time until receiving a new grouping message beacon from a time point when a response message is transmitted toward the leader of the domain group 1.

Thereafter, when the domain gateway receives a new grouping message beacon within a predetermined time, the domain gateway transmits an ACK message to a leader of the domain group 1 (S207).

Thereafter, the leader of the domain group 1, having received ACK from the domain gateway, includes a domain of the domain gateway having transmitted ACK in a domain group (S208). Further, by receiving an ID CBF_Domain from the domain gateway, the leader updates an ID CBF_Domain group.

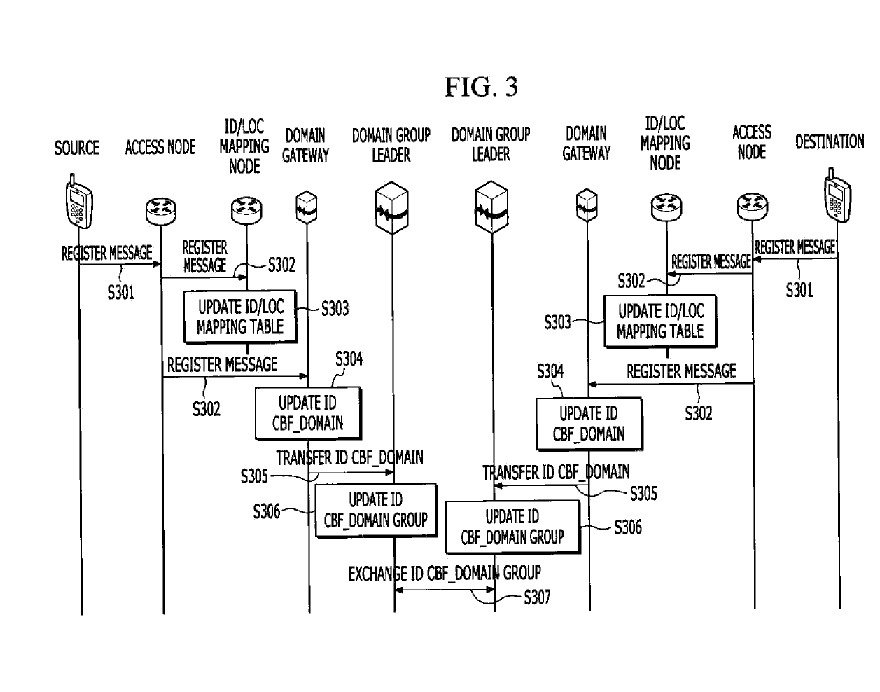

FIG. 3 is a flowchart illustrating a register procedure of a communication object according to an exemplary embodiment of the present invention.

Referring to FIG. 3, each communication object first transmits a register message to an access node of a domain (S301). In FIG. 3, the communication object includes a source that transmits a packet and a destination that receives a packet.

Thereafter, the access node transfers a register message that is received from a source communication object to an ID/LOC mapping node and a domain gateway according to an ID/LOC mapping management method of a domain A (S302).

When the ID/LOC mapping node receives a register message, the ID/LOC mapping node stores ID/LOC mapping information of a source communication object (S303). A communication provider may determine a node that should store ID/LOC mapping information of the source communication object. For example, a plurality of communication providers may cooperate to store ID/LOC mapping information at an ID/LOC mapping node adjacent to a source communication object. Alternatively, each communication provider may store ID/LOC mapping information at a previously allocated node for every source communication object.

In this case, when a mapping information management method of the ID/LOC mapping node is DHT, the access node may transfer an ID/LOC value of a source communication object so that the ID/LOC mapping node may add an ID/LOC value. When mapping information of the ID/LOC mapping node is managed by a central server, the access node may transfer an ID/LOC value of a source communication object to the central server.

When the domain gateway receives a register message, the domain gateway adds ID of a source communication object to an ID CBF_Domain (S304), and transfers an ID CBF_Domain value in which ID of the source communication object is updated to a leader of a domain group to which the domain A belongs (S305). In this case, the domain gateway may transfer an updated ID CBF_Domain to a domain group leader only at a predetermined time.

Thereafter, the domain group leader updates an ID CBF_Domain Group value (S306) and exchanges a domain group leader of another domain group and the updated ID CBF_Domain Group (S307).

According to an exemplary embodiment of the present invention, ID/LOC mapping information is formed in a domain unit, and even if a location of a communication object is changed in a domain, a location change of the communication object is not notified to the outside of the domain. When the communication object changes a location thereof to another domain, the ID CBF_Domain and the ID CBF_Domain Group are updated and thus a location change of the communication object may be notified to the outside of the domain. That is, a location change message of a communication object moving to another domain may be abbreviated to CBF. In an exemplary embodiment of the present invention, a path in which a location change message is transferred may be defined to a hierarchical structure, and thus location change messages of each communication object may be collected and abbreviated to a CBF. A location change message of a communication object, is not changed according to a specific host, service, and contents, and may be independently transferred by a hierarchical structure.

Further, in general, when many nodes share the same information, much time is consumed, but according to an exemplary embodiment of the present invention, because domain group leaders can exchange ID CBF_Domain information through a given time and path, a time consumed when sharing the same information can be shortened and a convergence time problem does not occur. That is, in the present invention, as a time in which the domain gateway provides an ID CBF_Domain to the domain group leader and an ID CBF_Domain Group exchange time between domain group leaders are set according to a predetermined cycle, a convergence time problem of LOC information does not occur.

Further, according to an exemplary embodiment of the present invention, ID of a communication object existing at a domain is stored at an ID CBF_Domain, and as ID/LOC mapping information is managed with a method in which a domain is determined, mobility may be supported. In this case, only in a domain in which an information communication object exists, ID and LOC mapping information is managed and thus an LOC update message within a domain may be minimized.

Accordingly, when a communication object moves between domains belonging to the same domain group, if the communication object requests registry to a new domain, a new domain adds ID of a requested communication object to an ID CBF_Domain, and in an ID CBF_Domain of a previous domain, the new domain may instruct to delete ID of the communication object to the previous domain.

When the communication object moves between domains belonging to another domain group, the communication object reports to a leader of a new domain group and requests registry to a new domain. Thereafter, the leader of the new domain group updates an ID CBF_Domain Group and reports registry of the communication object to a previous domain group leader, and thus the previous domain group leader may delete an identifier of a communication object that is moved from the ID CBF_Domain Group.

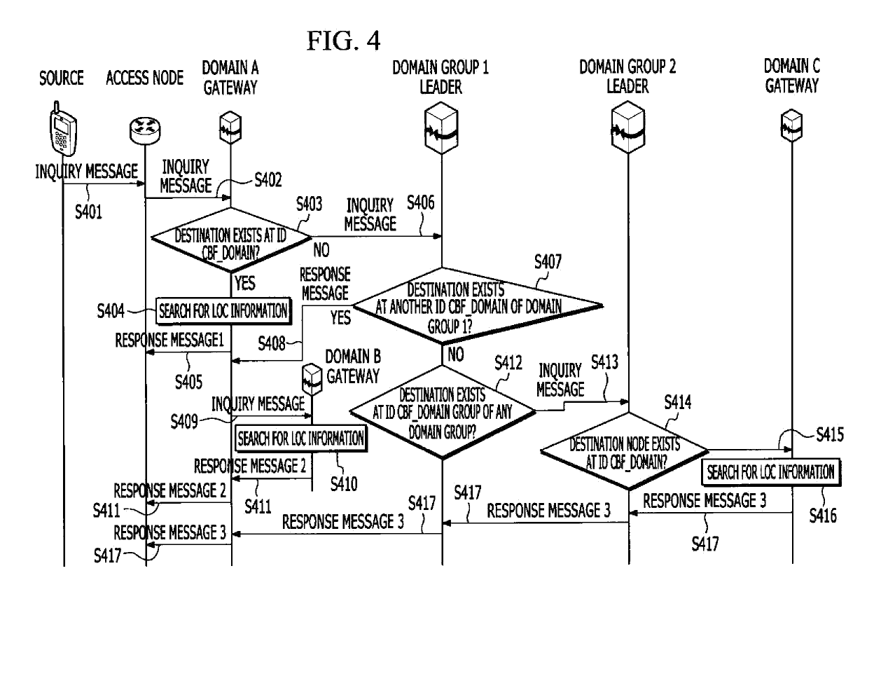

FIG. 4 is a flowchart illustrating an id/loc mapping inquiry procedure according to an exemplary embodiment of the present invention.

Referring to FIG. 4, in order for a source to transmit a packet to a destination, the source transmits an ID/LOC inquiry message of a destination to a domain gateway of a domain A through an access node. Thereafter, the domain gateway determines an ID CBF_Domain and determines whether a destination exists at a domain. Thereafter, when the destination exists at the domain, the domain gateway searches for and responds to LOC information of a destination by an ID/LOC mapping method.

A method of searching for LOC information within the domain includes, for example, a method of inquiring to a central server and obtaining LOC information of a destination when using one central server. Further, when using a chord algorithm that is included in a content addressable network (CAN) in a distributed hash table method, LOC information may be obtained by inquiring to a node that manages ID/LOC mapping information by a rule that is determined in a chord. In this case, the chord forms ID space with a ring, and a node that stores ID/LOC mapping information within the ring is referred to as a successor, and the chord may arrive at a successor node using a finger table that each node has.

In an exemplary embodiment of the present invention, a source exists at a domain A, a domain gateway 1 manages an ID CBF_Domain of the domain A, a domain gateway 2 manages an ID CBF_Domain of a domain B, and a domain gateway 3 manages an ID CBF_Domain of a domain C. Further, the domain A and the domain B are different domains belonging to the same domain group, and the domain C belongs to a domain group that is different from that of the domains A and B. Hereinafter, 1) when a destination to receive a packet exists at the same domain as that of a source, 2) when a destination to receive a packet exists at another domain of the same domain group as that of a source, and 3) when a destination to receive a packet exists at a domain group different from that of a source, will be described.

1) When a Destination to Receive a Packet Exists at the Same Domain as that of a Source

When a domain gateway of the domain A receives an ID/LOC inquiry message of a destination that is transmitted from an access node that is connected to a source (S401 and S402), the domain gateway of the domain A searches for an ID CBF_Domain of the domain A and determines whether the destination exists at the domain A (S403).

Thereafter, the domain gateway 1 searches for LOC information of the destination according to an ID/LOC mapping method in which the domain A stores ID/LOC mapping information (S404) and transmits a response message1 of ID/LOC to the access node (S405).

2) When a Destination to Receive a Packet Exists at Another Domain of the Same Domain Group as that of a Source

When the destination node does not exist at the domain A, the domain gateway 1 transfers an ID/LOC inquiry message to a leader of the domain group 1 (S406). First, the leader of the domain group 1 searches for an ID CBF_Domain of several domains that are included in the domain group 1 and searches for ID of the destination (S407).

In this case, when the destination node exists at a domain B of other domains that are included in the domain group 1, the leader of the domain group 1 transmits an ID response message to the domain gateway 1 and notifies that the destination node exists at the domain B (S408).

Thereafter, the domain gateway 1 transfers an ID/LOC inquiry message to the domain gateway 2 (S409). Thereafter, the domain gateway 2 searches for LOC information of the destination according to an ID/LOC mapping method of the domain B (S410), and transfers a response message 2 of ID/LOC to an access node through the domain gateway 1 (S411).

In this case, when the domain A and the domain B use LOC of the same system, the domain A and the domain B can understand LOC of the other party, but when the domain A and the domain B use LOC of a different system, the domain A and the domain B cannot understand LOC of the other party. Therefore, when both domains use LOC of the same system, a response to an ID/LOC inquiry message includes LOC, but when both domains use LOC of a different system, a response to the ID/LOC inquiry message uses ID and ACK without LOC.

In order to obtain ID/LOC mapping information in another node, the domain gateway transmits a corresponding ID/LOC inquiry message to a domain group leader. The domain group leader searches for an ID CBF_Domain in which the remaining domain gateways, except for a domain gateway that transmits an inquiry message, transmit among domain gateways in which the domain group leader manages, and determines whether ID/LOC mapping information exists at the remaining domain gateways. Thereafter, the domain group leader transfers an ID/LOC inquiry message to a domain gateway having ID/LOC mapping information and obtains a response to ID/LOC mapping information. Alternatively, the domain group leader transfers an ID/LOC inquiry message to a superordinate layer of the domain group leader to obtain a response to ID/LOC mapping information.

3) When a Destination to Receive a Packet Exists at a Domain Group that is Different from that of a Source

When ID of the destination node does not exist at any domain that is included in the domain group 1, a leader of the domain group 1 searches for an ID CBF_Domain Group of several domain groups and searches for ID of the destination (S412).

Thereafter, when the leader of the domain group 1 determines an ID CBF_Domain Group of several domain groups, if the destination node exists at the domain group 2, the leader of the domain group 1 again transfers an ID/LOC inquiry message to a leader of the domain group 2 (S413). The leader of the domain group 2 searches for ID CBF_Domains of several domains and searches for a domain in which ID of the destination exists (S414).

Thereafter, when ID of the destination exists at an ID CBF_Domain of the domain C, the leader of the domain group 2 transfers an ID/LOC inquiry message to a domain gateway 3 (S415). Thereafter, the domain gateway 3 searches for LOC information of the destination according to an ID/LOC mapping method of the domain C (S416), and transmits an ID/LOC response message 3 to the leader of the domain group 2 (S417). The leader of the domain group 2, having received a response, transfers a response to the leader of the domain group 1 and then transfers the response message 3 of ID/LOC to the access node through the domain gateway 1 (S417).

In this case, when the domain A and the domain C use the same LOC system, the response includes LOC, but when the domain A and the domain C use different LOC systems, the destination ID and ACK are used for the response.

That is, as described above, according to an exemplary embodiment of the present invention, data may be routed using an ID/LOC inquiry message and an ID/LOC response message. In this case, the ID/LOC response message may include recommendation information about a path that may be used for data routing, and the ID/LOC response message may be transmitted to an inverse path of the ID/LOC inquiry message.

Further, another exemplary embodiment of the present invention may be applied regardless of whether a hierarchical structure of communication object ID exists. For example, when ID of a communication object is IPv4 (hierarchical structure), the remaining bits of IPv4 32 bits may be padded to 0 to correspond to a length of predetermined ID. Further, when a communication object is 3GPP (a flat structure), a value that is obtained by inputting IMSI to a hash function may be used as ID of a CBF or a value that is obtained by inputting a public key to a hash function may be used as ID of a CBF.

Further, in another exemplary embodiment of the present invention, by enabling ID/LOC mapping table information to remain within a domain, location information of a communication object can be protected.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling routing in which a domain comprising a plurality of nodes that are operated with the same policy enters a first domain group comprising a plurality of domains that are different from the domain through a domain gateway of the domain, the method comprising:
receiving a plurality of beacons that are broadcasted from a plurality of domain groups;
determining a policy of the plurality of domain groups by analyzing the plurality of beacons;
transmitting a response message to the beacon to the first domain group that is selected according to the policy of the plurality of domain groups;
receiving a grouping beacon from the first domain group; and
transmitting, when the grouping beacon is received within a predetermined time, an ACK message to the first domain group.

2. The method of claim 1, wherein each beacon of the plurality of beacons comprises an intrinsic number and pattern of a domain group that broadcasts the beacon.

3. The method of claim 2, wherein the determining of a policy comprises determining information about a policy in which the domain group is operated by analyzing the pattern.

4. The method of claim 1, wherein the response message comprises a domain identifier of the domain.

5. The method of claim 4, wherein the receiving the grouping beacon, from a domain group leader of the first domain group, transmitted after a predetermined time from the time that the first domain group receives the response message, and the grouping beacon comprises the domain identifier and an intrinsic number of the first domain group.

6. The method of claim 1, further comprising transmitting identifier table information including an identifier of a communication object that is connected to the plurality of nodes to the first domain group, after transmitting the ACK message.

7. The method of claim 6, wherein in the domain, the identifier is managed with the identifier table information, and the identifier and a locator of the communication object are mapped according to an identifier/locator mapping method of the domain.

8. The method of claim 7, wherein the identifier is recorded in the identifier table information with a counting bloom filter.

9. A method of controlling routing in which a domain group comprising a plurality of domains updates identifier table information, the method comprising:
receiving, when a communication object enters an area of a first domain of the plurality of domains, first identifier table information of the first domain to which an identifier of the communication object is added from the first domain;
updating second identifier table information of the domain group using the first identifier table information; and
reporting that the communication object is registered at the first domain to a domain group that is located before the communication object enters.

10. The method of claim 9, wherein the plurality of domains comprise a plurality of nodes that are operated with the same policy, and the communication object is connected to at least one node of the plurality of nodes.

11. A method of controlling routing in which a domain group comprising a plurality of domains searches for a destination, the method comprising:
receiving an inquiry message about identifier and locator information of the destination;
determining identifier table information that the domain group has and searching for the identifier; and
transferring, when the identifier exists in a first domain of a plurality of domains that are included in the domain group, the inquiry message to a domain gateway of the first domain.

12. The method of claim 11, further comprising:
searching for, when the identifier does not exist in identifier table information, the identifier table information that a other domain group different from the domain group has; and
transferring, when the identifier exists in a second domain of a plurality of domains that are included in the other domain group, the inquiry message to the other domain group.

13. The method of claim 11, wherein the domain group has entire identifier table information that a plurality of domains that are included in the domain group have.

14. The method of claim 12, wherein the domain group shares the identifier table information that a other domain group that is different from the domain group has.

15. The method of claim 11, wherein the plurality of domains comprise a plurality of nodes that are operated with the same policy, and a communication object is connected to at least one node of the plurality of nodes.
